(19) United States
(12) Patent Application Publication
(10) Pub. No.: US 2015/0085818 A1
(43) Pub. Date: Mar. 26, 2015

(54) RESOURCE ALLOCATION METHOD FOR D2D COMMUNICATIONS, BASE STATION USING THE SAME, AND USER EQUIPMENT USING THE SAME

(71) Applicants: Yen-Ming Huang, Taipei City (TW); Bor-Ching Su, Taipei City (TW)

(72) Inventors: Yen-Ming Huang, Taipei City (TW); Bor-Ching Su, Taipei City (TW)

(73) Assignee: ASUSTEK COMPUTER INC., Taipei City (TW)

(21) Appl. No.: 14/497,351

(22) Filed: Sep. 26, 2014

Related U.S. Application Data
(60) Provisional application No. 61/883,176, filed on Sep. 26, 2013.
(60) Provisional application No. 61/994,142, filed on May 16, 2014.
(60) Provisional application No. 62/037,615, filed on Aug. 15, 2014.

(51) Int. Cl. H04L 5/00; H04W 76/02

(52) U.S. Cl. CPC H04L 5/0037; H04L 5/0005; H04W 76/023
USPC 370/330

(57) ABSTRACT

A resource allocation method for device to device (D2D) communications and a base station using the same are provided. In the method, resource patterns are assigned, wherein each of the resource patterns comprises resource groups comprising the resource block(s). Frequency index and time index of each resource group in a time-frequency domain of resource pattern are determined, and there exists at least one of the resource patterns such that the time index of a first resource group and the time index of a second group are different. The resource groups of each resource pattern to the UEs are respectively assigned according to the frequency index and the time index of each of the resource groups in the time-frequency domain of each resource pattern.

### CROSS REFERENCE TO RELATED APPLICATION

This application claims the priority benefit of U.S. provisional application Ser. No. 61/883,176, filed on Sep. 26, 2013, U.S. provisional application Ser. No. 61/994,142, filed on May 16, 2014, and U.S. provisional application Ser. No. 62/037,615, filed on Aug. 15, 2014. The entirety of each of the above-mentioned patent applications is hereby incorporated by reference herein and made a part of specification.

### BACKGROUND OF THE DISCLOSURE

1. Field of the Disclosure

The present disclosure generally relates to a method of resource allocation for device to device (D2D) communications, a base station using the same method, and a user equipment using the same method.

2. Description of Related Art

Device to Device (D2D) communication is a blossoming technology that enables a user equipment (UE) to directly communicate with another UE without requiring a base station to relay user data in between. In the third generation partnership project (3GPP) Long Term Evolution (LTE) specification, the Proximity Services (ProSe) standards relate to D2D communications or direct communications. For the typical ProSe technology, the first stage of D2D operation is to discover UEs (or devices) in proximity. A UE that participates in D2D discovery would transmit or receive a discovery signal from which the UE may acquire the information of proximity UEs and may subsequently decide to establish connection(s) with target UE(s). The second stage of D2D operation is typically to communicate with target UE(s) directly. A UE participating D2D communication can unicast, groupcast, or broadcast data signal to one UE, several UEs, or all UEs without routing through a base station (e.g. eNB, macro site, pico site, etc. . . . ).

The signal transmission of D2D discovery or D2D communication could be allocated, for example, by an eNB within the network coverage. With eNB assistance, not only the problem of resource collisions could be avoided, but also some of the potential interferences could be managed. On the other hand, when a UE does not or cannot connect to an eNB or operator services, the UE may either search for another UE acting as virtual eNB (or cluster head) or may use a pre-configured parameter based on a predetermined rule to determine its resource allocation for D2D communications. Therefore, resource allocations of D2D signal transmission could be critical for efficient resource utilization and reliable of signal detection.

However, the resource allocation of D2D discovery or D2D communication has been subject to the following constraints. The first constraint is half-duplex. For example, any UE participating in the D2D discovery process or in the D2D communication does not transmit and receive signals from other UEs at the same time. The second constraint is the Near-Far problem (or radio frequency (RF) blocking). For example, suppose that there are three UEs, UE1, UE2, and UE3, that participate in D2D discovery or D2D communication in a ProSe coverage. Suppose that UE1 receives two signals transmissions from UE2 and UE3 under frequency division multiplexing (FDM), and UE2 is much closer to UE1 than UE3, as the power of signals received at UE1 is not controlled by an eNB or a virtual eNB but is determined by a relative distance between UE1 and another UE, signals from UE2 may either drown out or block signals from UE3 or may cause severe interferences to the signals from UE3. In addition, the third constraint is the deep fade of a fading channel. For example, a UE transmitting signals on a channel may encounter deep fade (i.e. the channel attenuation is large due to destructive interference) resulting in the failure detection of some other UEs.

Furthermore, considering the issue of co-channel interference of D2D signal transmission stemmed from reusing the radio resources by the UEs in other macro sites, assuming that a macro site (MS) has three sectors, UEs in a MS may follow the same strategy of resource allocation for their D2D signals transmissions. Considering the case that UEs transmit D2D discovery or communication signals in different MSs but use the same radio resource, FIG. 1A and FIG. 1B serve as examples illustrating co-channel interferences of D2D signal transmissions. Referring to 1A, UE 106 may receive a D2D signal from UE 105 served by MS 101 but meanwhile may also receive a D2D signal from UE 107 served by MS 103. Next, referring to FIG. 1B which illustrates radio resource in time-frequency domain of MS 101 and MS 103, once the radio resource 111 allocated for UE 107 becomes overlapped with the radio resource 113 allocated for UE 106, UE 106 may suffers the co-channel interference from UE 107. Suppose that the received power of this interference is comparable with the received power of desired signal for UE 106, very poor detection performance for UE 106 could be the end result. Therefore, in the present disclosure, a resource allocation method could be proposed to resolve those constraints and problems of D2D communications.

### SUMMARY OF THE DISCLOSURE

The present disclosure proposes a resource allocation method for D2D communications, a base station using the same, and a user equipment using the same method, by performing hopping mechanism for resource allocation of D2D discovery or communication signal transmission, constraints and problems of D2D communications would be resolved.

Specifically, the present disclosure proposes a resource allocation method, used by a scheduling device to assign resource blocks to user equipments (UEs) in D2D communications. The scheduling device can be a base station or a UE. The method would include at least but not limited to: assigning resource patterns, wherein each of the resource patterns comprises resource groups, and each of the resource groups comprises the resource block(s), determining frequency index and time index of each of the resource groups in a time-frequency domain of each of the resource patterns, there exists at least one of the resource patterns such that the time index of a first resource group and the time index of a second group are different, and assigning the resource groups of each of the resource patterns to the UEs respectively according to the frequency index and the time index of each of the resource groups in the time-frequency domain of each of the resource patterns. Also a UE can utilize the method to realize which resource is utilized for D2D communication.

The present disclosure proposes a resource allocation method, used by a scheduling device to assign resource blocks to UEs in D2D communications. The scheduling device can be a base station or a UE. The method would include at least but not limited to: determining frequency index and time index of each of the resource groups in a time-frequency domain for each of resource patterns, and the frequency index and the time index fulfil the following conditions:

$$0 \leq {g}_{l} ( k ) \leq M - 1 , ∀ l ∈ \{ 0 , 1 , … , L - 1 \} and$$

$$∀ k ∈ \{ 0 , 1 , … , K - 1 \}$$

$$0 \leq {i}_{l} ( k ) \leq N - 1 , ∀ l ∈ \{ 0 , 1 , … , L - 1 \} and$$

$$∀ k ∈ \{ 0 , 1 , … , K - 1 \}$$

$$( {g}_{{l}_{1}} ( k ) , {i}_{{l}_{1}} ( k ) ) \neq ( {g}_{{l}_{2}} ( k ) , {i}_{{l}_{2}} ( k ) ) , ∀ {l}_{1} , \\ {l}_{2} ∈ \{ 0 , 1 , … , L - 1 \} , {l}_{1} \neq {l}_{2} , ∀ k ∈ \{ 0 , 1 , … , K - 1 \}$$

$$∀ {l}_{1} , {l}_{2} , {l}_{3} ∈ \{ 0 , 1 , … , L - 1 \} , {l}_{1} \neq {l}_{2} \neq {l}_{3} \neq {l}_{1} , \\ ∃ k ∈ \{ 0 , 1 , … , K - 1 \} such that$$

$$\{ \begin{matrix}{i}_{{l}_{1}} ( k ) \neq {i}_{{l}_{2}} ( k ) & \\ \vert {g}_{{l}_{2}} ( k ) - {g}_{{l}_{3}} ( k ) \vert \geq 2 or & {i}_{{l}_{2}} ( k ) = {i}_{{l}_{3}} ( k )\end{matrix} \\ ∃ {k}_{1} , {k}_{2} ∈ \{ 0 , 1 , … , K - 1 \} , {k}_{1} \neq {k}_{2} , such that \\ {g}_{l} ( {k}_{1} ) \neq {g}_{l} ( {k}_{2} ) , ∀ l ∈ \{ 0 , 1 , … , L - 1 \} ;$$

wherein gₗ(k) and iₗ(k) are the frequency index and the time index of the l^{th} resource group in the k^{th} resource pattern, respectively; M is the number of frequency indices, N is the number of time indices for resource groups to reside in each of the resource patterns, and L is the number of UE groups in each of the resource patterns.

The present disclosure proposes a resource allocation method for D2D communications of UEs. The method would include at least but not limited to: a first UE utilizes a first resource group to perform the D2D communication; a second UE utilizes a second resource group to perform the D2D communication; wherein there exists at least one of resource patterns such that a time index of the first resource group and a time index of the second group are different.

The present disclosure proposes a resource allocation method, used by a scheduling device to assign resource blocks to UEs in D2D communications. The scheduling device can be a base station or a UE. The method would include at least but not limited to: determining frequency index and time index of each of resource groups in a time-frequency domain for each of the resource patterns, and the frequency index and the time index fulfil the following conditions:

gₗ(k)=(gₗ(0)+p·k mod M)mod M

iₗ(k)=(iₗ(0)+q·k·(gₗ(0)+r)mod N)mod N

, wherein k is index of the plurality of resource patterns, M is the number of occupying spectra of the resource groups in each of the resource patterns, N is the number of time periods of the resource groups in each of the resource patterns, p is a positive integer which is relatively prime with M, q is a positive integer which is relatively prime with N, r is an integer in the range {0, 1, . . . , N−1}, gₗ(k) is the frequency index of the l^{th} resource group in the k^{th} resource pattern, iₗ(k) is the time index of the l^{th} resource group in the k^{th} resource pattern.

The present disclosure proposes a scheduling device. The scheduling device can be a base station or a UE. The scheduling device comprises a transceiver and a control circuit. The transceiver transmits and receives wireless signals. The control circuit to the transceiver and is configured for assigning resource patterns, wherein each of the resource patterns comprises resource groups, and each of the resource groups comprises the resource block(s), determining frequency index and time index of each of the resource groups in a time-frequency domain of each of the resource patterns, there exists at least one of the resource patterns such that the time index of a first resource group and the time index of a second group are different, and assigning the resource groups of each of the resource patterns to the UEs respectively according to the frequency index and the time index of each of the resource groups in the time-frequency domain of each of the resource patterns.

The present disclosure proposes a scheduling device. The scheduling device can be a base station or a UE. The scheduling device comprises a transceiver and a control circuit. The transceiver transmits and receives wireless signals. The control circuit to the transceiver and is configured for assigning a of resource patterns, wherein each of the resource patterns comprises resource groups, and each of the resource groups comprises resource block(s); determining frequency index and time index of each of resource groups in a time-frequency domain for each of the resource patterns, and the frequency index and the time index fulfil the following conditions:

gₗ(k)=(gₗ(0)+p·k mod M)mod M

iₗ(k)=(iₗ(0)+q·k·(gₗ(0)+r)mod N)mod N

, wherein k is index of the plurality of resource patterns, M is the number of occupying spectra of the resource groups in each of the resource patterns, N is the number of time periods of the resource groups in each of the resource patterns, p is a positive integer which is relatively prime with M, q is a positive integer which is relatively prime with N, r is an integer in the range {0, 1, . . . , N−1}, gₗ(k) is the frequency index of the l^{th} resource group in the k^{th} resource pattern, iₗ(k) is the time index of the l^{th} resource group in the k^{th} resource pattern. Note that according to the system requirements, in one embodiment of the present disclosure, a resource group may be regarded as a resource block.

Based on the above descriptions, the embodiments of the present disclosure provide a resource allocation method for D2D communications and a base station using the same. Frequency indices and time indices of the resource groups in a time-frequency domain of each of the resource patterns are determined, wherein the frequency index of each of the resource groups in the time-frequency domain of two of the resource patterns which is adjacent with each other in the time domain would be different. Next, the resource groups would be assigned to UEs respectively according to the frequency indices and time indices. Accordingly, constraints and co-channel interference problem of D2D communications would be resolved.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B are examples illustrating co-channel interference of D2D signal transmission.

FIG. 2 is a flow chart illustrating a resource allocation method used by a base station according to an embodiment of the disclosure.

FIG. 3 is an example illustrating a time-frequency resource structure according to an embodiment of the disclosure.

FIG. 4A to FIG. 4C are examples illustrating resource allocation according to an embodiment of the disclosure.

FIG. 5A and FIG. 5B are examples illustrating dealing with co-channel interference according to an embodiment of the disclosure.

FIG. 6A and FIG. 6B are examples illustrating resource allocation according to an embodiment of the disclosure.

FIG. 7A and FIG. 7B are examples illustrating resource allocation according to an embodiment of the disclosure.

FIG. 8 is an example illustrating resource allocation according to an embodiment of the disclosure.

FIG. 9A and FIG. 9B are examples illustrating resource allocation according to an embodiment of the disclosure.

FIG. 10 shows a multiple access wireless communication system according to an embodiment of the disclosure.

FIG. 11 is a simplified block diagram of an embodiment of a transmitter system and a receiver system in a MIMO system.

FIG. 12 shows an alternative simplified functional block diagram of a communication device according to an embodiment of the disclosure.

FIG. 13 is a simplified block diagram of the program code shown in FIG. 12 in accordance with an embodiment of the disclosure.

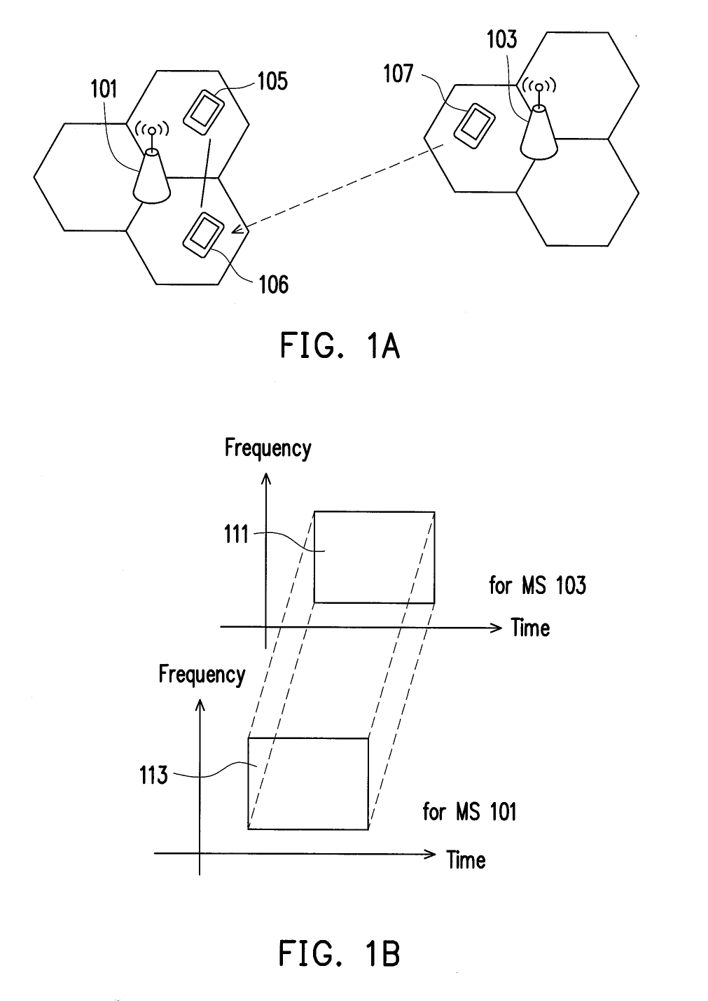

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

In transmission resource structure of LTE, radio resources of time domain and frequency domain both could be allocated flexibly as radio resource could be divided in the time domain and in the frequency domain. A physical resource block (PRB) could for example be considered as the most basic unit to describe a radio resource for data transmission in LTE, and a PRB typically has the duration of 0.5 ms in the time domain and would contain 12 subcarriers for each OFDM symbol in frequency domain. In general, the radio resources are allocated by a base station such as an evolved Node B (eNB) for the case of LTE, and the basic requirement of resource allocation is to provide radio resources without resource collisions. One of the aims in the proposed solution is to provide resource allocations for signal transmissions used in D2D discovery or D2D communications in order to achieve no resource collision. In this disclosure, the proposed hopping mechanisms for resource allocation would also address issues such as half duplex constraint, near-far problem, and deep fade in D2D channel links.

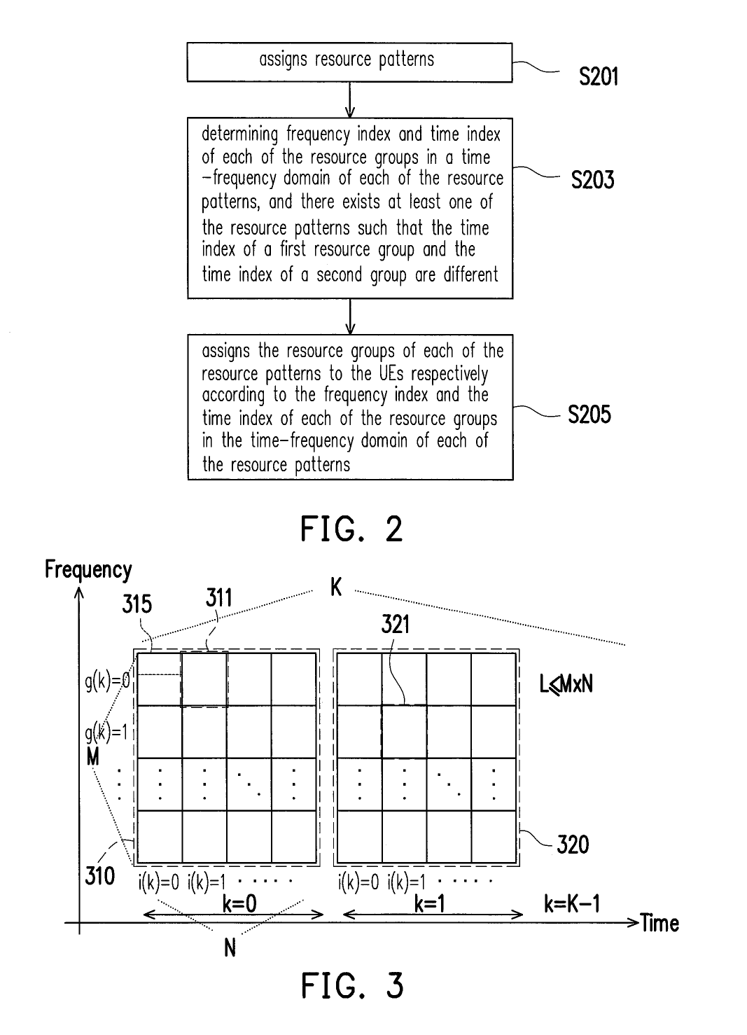

FIG. 2 is a flow chart illustrating a resource allocation method used by a scheduling device according to an embodiment of the disclosure. In this embodiment, the scheduling device may be a base station or a user equipments (UE). In step S201, the scheduling device would assign resource patterns. Each of the resource patterns includes resource groups, and each of the resource groups includes the resource blocks. Specifically, in view of time-frequency resource structure, definitions for D2D resource block (DRB), D2D resource group (DRG), and D2D resource pattern (DRP) are provided. A DRB could be considered as the most basic unit of radio resource for one UE (device) signal transmission in D2D discovery or D2D communication. However, the size of a DRB could vary according to different requirements of D2D discovery or D2D communication. For example, DRB could be 0.5 ms in time domain and contains 12 subcarriers for each OFDM symbol in frequency domain just like PRB of LTE structure. A DRG could be one or more DRBs (e.g. 5, 10, 20 DRBs). In other words, a DRB is an element of DRG. A DRP can have one or more DRGs (e.g. 4, 9, 12 DRGs). Neither DRBs in a DRG nor DRGs in a DRP are constrained by continuity. DRPs in overall time-frequency resource structure can be allocated in various forms (e.g. regular D2D cycle or irregular D2D cycle) which will be described later.

For example, FIG. 3 is an example illustrating a time-frequency resource structure according to an embodiment of the disclosure. For this embodiment, a DRP (e.g. DRPs 310 and 320) has L′=M×N DRGs (e.g. 16=4×4), where M is the number of frequency indices and N is the number of time indices for DRGs to reside in a DRP, wherein M and N are positive integer and larger than one (e.g. 2, 4, 6, etc). In addition, a DRG (e.g. DRGs 311 and 321) has one or more DRB (e.g. DRB 315). Let L is the number of UE groups in a DRP, wherein L≦L′ (e.g. L=13, L′=16, 13≦16). Let K be the number of DRPs, wherein K is a positive integer (e.g. 4, 5, 6, etc). DRP(gₗ(k),iₗ(k)) denotes the position (DRG) for the l^{th} group of UEs (devices) to transmit signal in the k^{th} DRP, where gₗ(k) and iₗ(k) are the frequency index and the time index of the l^{th} DRG in the k^{th} DRP, respectively, wherein (0≦l≦L=1) and (0≦k≦K−1). Take DRGs 311 and 321 as examples, positions of DRG 311 and 321 are DRP(0,1) in DRP 311 and DRP(1,1) in DRP 321, respectively.

In step S203, the scheduling device determines frequency index and time index of each of the resource groups in a time-frequency domain of each of the resource patterns, and there exists at least one of the resource patterns such that the time index of a first resource group and the time index of a second group are different. In this embodiment, for the first resource group, there are at least two of the resource patterns such that the frequency index of the first resource group in the two of the resource patterns are different, and a pair of the frequency index and the time index of each of the resource groups is presented as a position in each of the resource patterns.

In one embodiment, the scheduling device determines a frequency hopping value of the frequency index in the time-frequency domain of each of the resource patterns, and assigns the frequency index of each of the resource groups in the time-frequency domain of each of the resource patterns to hop according to the frequency hopping value between the one of the resource patterns and the another one of the resource patterns. In addition, the scheduling device determines a time hop value of the time index of each of the resource groups in the time-frequency domain of each of the resource patterns, and assigns the time index of each of the resource groups in the time-frequency domain of each of the resource patterns to hop according to the time hop value between the time-frequency domain of the one of the resource patterns and the another one of the resource patterns.

For example, a concept would be to generate hopping resource patterns based on the original resource pattern (e.g. DRP 310 in FIG. 3) according to the rule of the following two equations (1) and (2) for the resource allocation of D2D discovery/D2D communication signal transmission:

gₗ(k)=(gₗ(0)+p·k mod M)mod M (1)

iₗ(k)=(iₗ(0)+q·k·(gₗ(0)+r)mod N)mod N (2)

Wherein k is index of DRP (e.g. DRPs 310 and 320 in FIG. 3), M is the number of occupying spectra of DRGs in a DRP, N is the number of time periods of DRGs in a DRP, p is a positive integer which is relatively prime with M, q is a positive integer which is relatively prime with N, r is an integer in the range {0, 1, . . . , N−1}, gₗ(k) is the index of occupying spectrum (i.e. frequency index) of the l^{th} DRG in the k^{th} DRP, iₗ(k) is the index of time period (i.e. time index) of the l^{th} DRG in the k^{th} DRP, and DRP(gₗ(k),iₗ(k)) is the position of the l^{th} DRG in the k^{th} DRP. Notice that k=0 and k≠0 represent the original DRP (e.g. DRP 310 in FIG. 3) and the generated hopping DRP (e.g. DRP 320 in FIG. 3), respectively. In addition, gₗ(0) and iₗ(0) can be arbitrarily chosen from the first DRP (or original DRP, k=0) (e.g. DRP 310 in FIG. 3), wherein lε{0, 1, . . . , N−1} denotes the l^{th} DRG. In present example, the frequency hopping value of the frequency index is p·k, and the time hop value of the time index is q·k·(gₗ(0)+r).

In another embodiment, the hopping pattern can be generated according to the following algorithm.

```
for k = 0 : K−1
        m(k) = [ m(0) + p*k ] mod M ; % frequency index
        n(k) = [ n(0) + q*k*(m(0)+r) ] mod N ; % time index
      if ( M > N, k = 2 )
          m’(0) = floor( m(0) / N ) ;
          n(k) = [ n(0) + q*1*( m’(0) + r) ] mod N ;
    else if ( M > N , k >= 3 )
          if m’(0) >= N
            m’’(0) = floor( m’(0) / N ) ;
            n(k) = [ n(k) + q*1*( m’’(0) + r ) ] mod N ;
            m’(0) = m’’(0) ;
          end
  end
end
```

More specifically, for k=T:K−1, the following equation can be used instead n(k)=n(k mod T), where

$$T = ⌈ \frac{log ( MN )}{log ( N )} ⌉ .$$

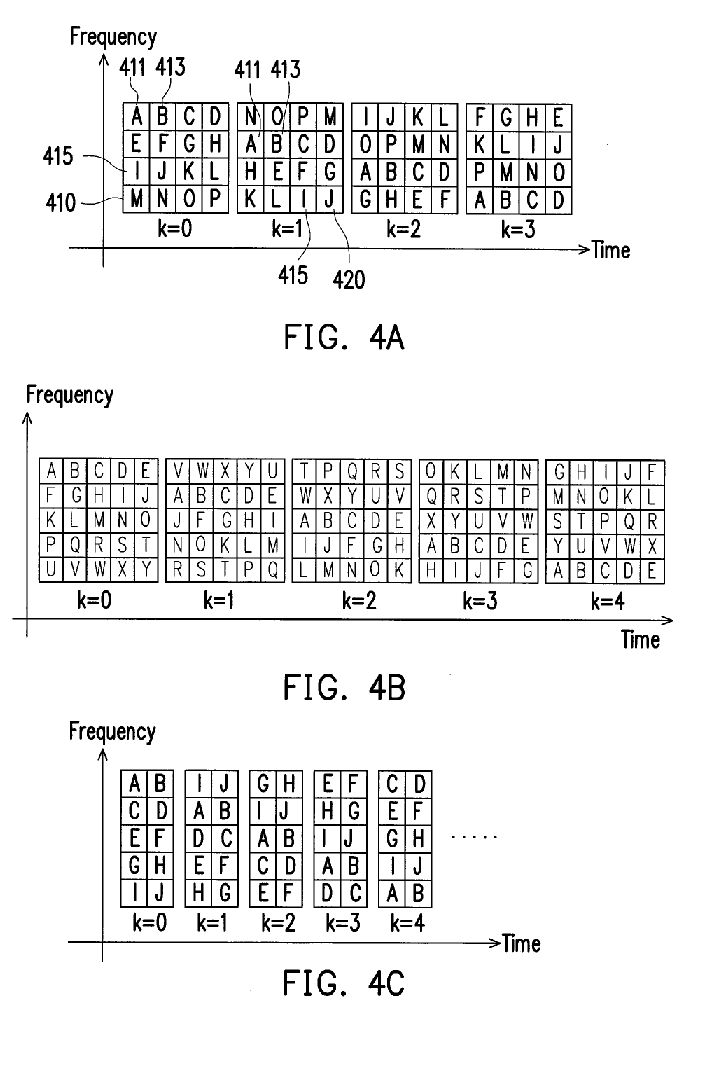

FIG. 4A to FIG. 4C are to illustrate embodiments of the present disclosure. For convenience, the capital letters denote different DRGs in the following figures. In FIG. 4A, there are four distinct DRPs with M=N=4, p=q=1, r=0, wherein frequency index of DRG 411 in DRP 410 (i.e. g_{A}(0)) is different from frequency index of DRG 411 in DRP 420 (i.e. g_{A}(1)). FIG. 4B presents five distinct DRPs with M=N=5, p=q=1, r=0. Even for the case of M≠N (M=5, N=2) with p=q=1, r=0 as shown in FIG. 4C, the rule of the two equations (1) and (2) would still apply.

The order of generated hopping DRPs could be interchanged. For example, if M=N, then p=q (i.e. M=N is the sufficient condition of p=q). If M≠N, the corresponding two values of p and q could still be found. There are K=lcm(M,N) distinct DRPs, where lcm(M,N) is the smallest positive integer that is divisible by both M and N. In accordance with the system/link requirements, there are flexibilities in the choice of K≦K′ or K′>K DRPs.

In step S205, the scheduling device assigns the resource groups of each of the resource patterns to the UEs respectively according to the frequency index and the time index of each of the resource groups in the time-frequency domain of each of the resource patterns.

Specifically, gₗ(k) and iₗ(k) can be chosen such that the following equations (3) and (4) are satisfied.

0≦gₗ(k)≦M−1,∀lε{0,1, . . . , L−1} and ∀kε{0,1, . . . , K−1} (3)

0≦iₗ(k)≦N−1,∀lε{0,1, . . . , L−1} and ∀kε{0,1, . . . , K−1} (4)

Equations (3) and (4) clarify the range of spectrum and time period for one DRP, respectively. There are (MN)^{KL} possible options to satisfy equations (3) and (4). Taking FIG. 4A as an example, gₗ(k) of DRG 411 is 0 which satisfies equation (3), and iₗ(k) of DRG 411 is 0 which is satisfy equation (4).

In one exemplary embodiment, the scheduling device assigns a first allocated resource group and a second allocated resource group of the resource groups in the time-frequency domain of each of the resource patterns to two of the UEs respectively, wherein the frequency index of the first allocated resource group and the frequency index of the second allocated resource group of the resource groups in the time-frequency domain of each of the resource patterns are different, and the time index of the first allocated resource group and the time index of the second allocated resource group of the resource groups in the time-frequency domain of each of the resource patterns are different. In this embodiment, gₗ(k) and iₗ(k) would be satisfied by equation (5) as in the following:

(gₗ1(k),iₗ1(k))≠(gₗ2(k),iₗ2(k)),∀lₗ,l₂ε{0,1, . . . , L−1},lₗ≠l₂,∀kε{0,1, . . . , K−1} (5)

Equation (5) is to ensure that there is no resource collision for any DRP (e.g. DRP 310 or 320 in FIG. 3, DRP 410 or 420 in FIG. 4A). Taking FIG. 4A as an example, DRG 411 is assigned to UE1, and DRG 413 is assigned to UE2, then (gₗ_{_{UE1}}(0),iₗ_{_{UE1}}(0))≠(gₗ_{_{UE2}}(0),iₗ_{_{UE2}}(0)) which is satisfied with equation (5). Furthermore, there are P_{L}^{L′} permutations in each DRP, where L(≦L′) denotes the number of used DRGs in a DRP (i.e. there are L′−L empty DRG zones).

In one exemplary embodiment, there exists at least one of the resource patterns such that the time index of a third resource group are different from the time index of the second resource group or the frequency index of the third group and the frequency index of the second group are not adjacent in the frequency domain. Specifically, the scheduling device assigns a third allocated resource group, a forth allocated resource group, and a fifth allocated resource group of the resource groups in the time-frequency domain of each of the resource patterns to three of the UEs respectively, wherein the time index of the third allocated resource group and the time index of the forth allocated resource group of the resource groups in the time-frequency domain of each of the resource patterns are different. For half-duplex constraint, gₗ(k) and iₗ(k) would be satisfied by equation (6) as in the following:

∀l₁,l₂ε{0,1, . . . , L−1},l₁≠l₂,∃kε{0,1, . . . , K−1} such that (s.t.) iₗ1(k)≠iₗ2(k) (6)

Therefore, the l₁ group of UEs is able to receive the signals transmitted from the l₂ group of UEs. Taking FIG. 4A as an example, DRG 411 is assigned to UE1, and DRG 413 is assigned to UE2, then iₗ_{_{UE1}}(0)≠iₗ_{_{UE2}}(0) which is satisfied with equation (6).

In this exemplary embodiment, the frequency index of the third allocated resource group and the frequency index of the forth allocated resource group of the resource groups in the time-frequency domain of each of the resource patterns are not adjacent in response to the time index of the forth allocated resource group and the time index of the fifth allocated resource group of the resource groups in the time-frequency domain of each of the resource patterns being different. For the near-far problem, the following equation (7) is defined with respect to the UE monitoring all resources merely (the UE does not transmit its signal in these DRPs):

$$∀ {l}_{1} , {l}_{2} ∈ \{ 0 , 1 , … , L - 1 \} , {l}_{1} \neq {l}_{2} , ∃ k ∈ \{ 0 , 1 , … , K - 1 \} \\ s . t . \{ \begin{matrix}{i}_{{l}_{1}} ( k ) \neq {i}_{{l}_{2}} ( k ) \\ or \\ {i}_{{l}_{1}} ( k ) = {i}_{{l}_{2}} ( k ) , \vert {g}_{{l}_{1}} ( k ) - {g}_{{l}_{2}} ( k ) \vert \geq 2\end{matrix} \qquad ( 7 )$$

In this embodiment, expect that even if two differently used DRGs are allocated on the same time index, they are not adjacent on frequency index. Taking FIG. 4A as an example, DRG 411 is assigned to UE1, and DRG 415 is assigned to UE3, then iₗ_{_{UE1}}(0)=iₗ_{_{UE3}}(0) and |gₗ_{_{UE1}}(0)−gₗ_{_{UE3}}(0)|=2 which satisfies equation (7).

For the near-far problem that involves three UEs (e.g. UE1, UE2, and UE3) (i.e., UE3 also intends to transmit its signal and receive the signals from UE1 or UE2 within these DRPs). Therefore, in one exemplary embodiment, the frequency index of the forth allocated resource group and the frequency index of the fifth allocated resource group of the resource groups in the time-frequency domain of each of the resource patterns are not adjacent. In another exemplary embodiment, the time index of the forth allocated resource group and the time index of the fifth allocated resource group of the resource groups in the time-frequency domain of each of the resource patterns are different. Then, the frequency index and the time index of each of the resource groups would be satisfied by equation (8) as in the following:

$$∀ {l}_{1} , {l}_{2} , {l}_{3} ∈ \{ 0 , 1 , … , L - 1 \} , {l}_{1} \neq {l}_{2} \neq {l}_{3} \neq {l}_{1} , \\ ∃ k ∈ \{ 0 , 1 , … , K - 1 \} , \\ s . t . \{ \begin{matrix}{i}_{{l}_{1}} ( k ) \neq {i}_{{l}_{2}} ( k ) \\ \vert {g}_{{l}_{2}} ( k ) - {g}_{{l}_{3}} ( k ) \vert \geq 2 or {i}_{{l}_{2}} ( k ) = {i}_{{l}_{3}} ( k )\end{matrix} \qquad ( 8 )$$

Notice that equation (8) implies equation (6) and then equation (6) implies equation (7). Therefore, the aforementioned equations (6) to (8) would satisfy all of these three constraints (for half-duplex constraint and two considerations of near-far problem). Taking FIG. 4A as an example, DRG 411 is assigned to UE1, DRG 413 is assigned to UE2, and DRG 415 is assigned to UE3, then iₗ_{_{UE1}}(1)≠iₗ_{_{UE2}}(1), iₗ_{_{UE2}}(1)≠iₗ_{_{UE3}}(1), and |gₗ_{_{UE2}}(1)−gₗ_{_{UE3}}(1)|=2 which satisfies equation (8).

Furthermore, in another embodiment, in order to ensures exploiting time-frequency diversity gain for reducing the probability of failure detection due to deep fade, the frequency index and the time index of each of the resource groups would be satisfied by equation (9) as in the following:

∃k₁,k₂ε{0,1, . . . , K−1},k₁≠k₂, s.t. gₗ(k₁)≠g₁(k₂),∃lε{0, 1, . . . , L−1} (9)

Taking FIG. 4A as an example, frequency index of DRG 411 in DRP 410 is different from frequency index DRG 411 in DRP 420 as gₗ(0)≠gₗ (1) which satisfies equation (9).

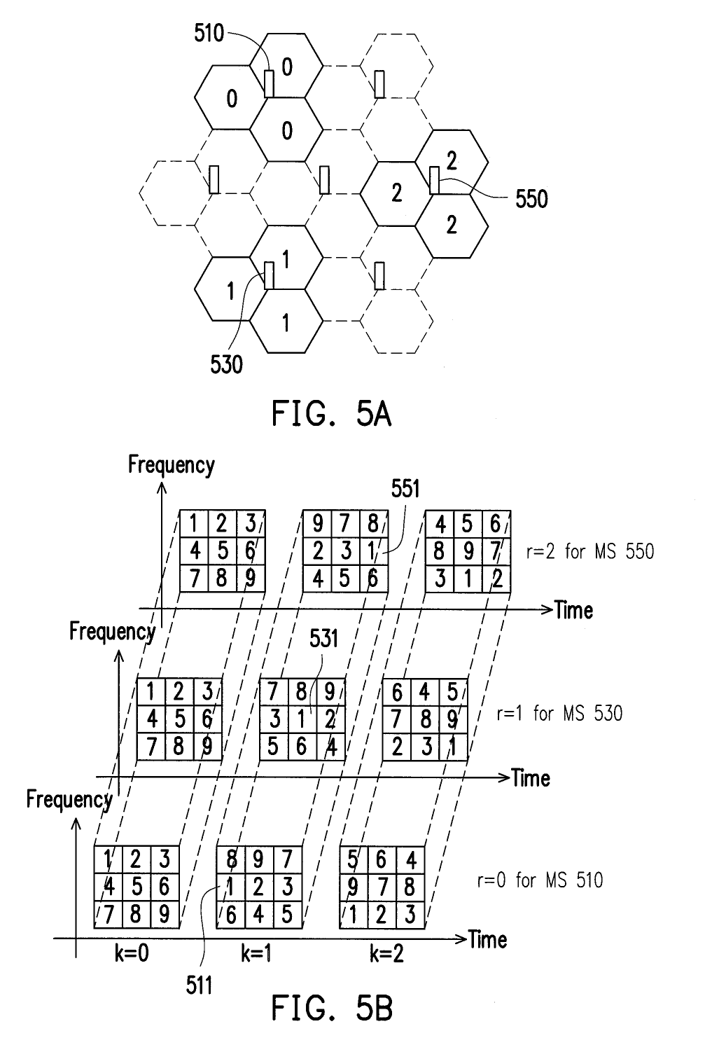

It should be noticed that, the equations (1) and (2) would satisfy the above equations (3) to (9). Therefore, the proposed resource allocation method can handle with half duplex constraint, near-far problem causing the in-band emission, and deep fade in D2D channel links. Furthermore, consider the issue of co-channel interference of D2D signal transmission in cellular networks, in order to cope with this impediment in D2D discovery and D2D communication, a first base station and a second base station use different r value for the UEs to derive the time index and frequency index. Specifically, the values of r in the equation (2) are chosen to be different for the resource allocation of the UEs transmitting signals in the base stations using the same resource pool. That is, a resource pool can be reused by the UEs in other base stations. Take a simple scenario as shown in FIG. 5A for example, UEs transmitting signals in MSs 510, 530, and 550 use the same resource pool. The numbers in the hexagons in MSs 510, 530, and 550 denote the corresponding values of r for their resource allocation. By using the parameters such as M=N=K=3, L=9, p=q=1, FIG. 5B depicts the corresponding distribution of DRBs utilization based on the proposed hopping mechanism (i.e. equations (1) and (2)). For example, DRG 511 of MS 510 as r=0, DRG 531 of MS 530 as r=1, and DRG 551 of MS 550 as r=2 would not be collided.

Therefore, the advantages of DRG-based resource allocation are to reduce computation complexity and to lower latency for both base station and the UE acting as virtual base station. It also provides the opportunity that the signal transmission of the UEs with similar properties can be allocated in the same DRG. Thus, the overall D2D operation can be performed more efficiently.

Moreover, there is one further advantage in that the generated hopping DRPs provide diversity gain for signal transmission over wireless channel. DRG-based hopping scheme may guarantee that the separation between successive carriers (time intervals) of same information-bearing signal equals or exceeds the coherence bandwidth (coherence time) of the channel for each DRB.

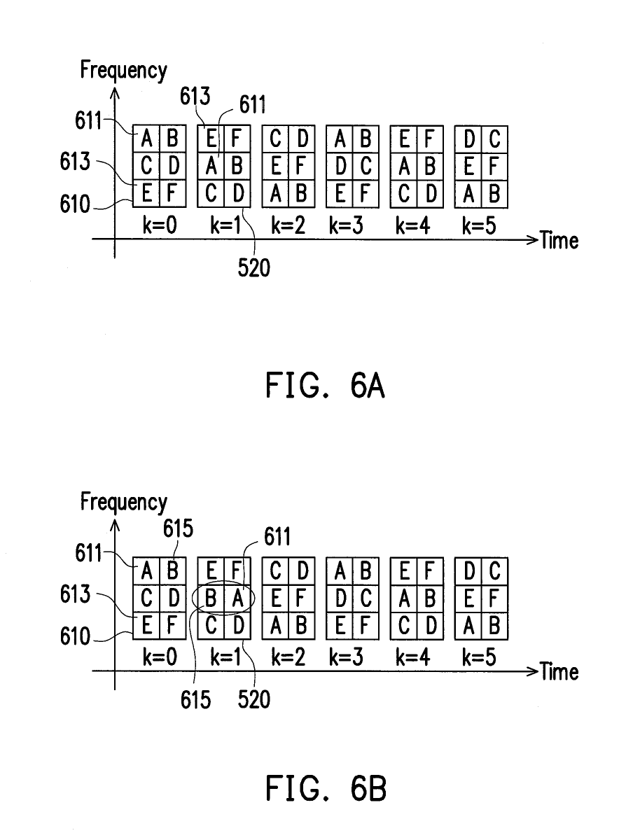

In one exemplary embodiment, consider the row of original DRP satisfies (gₗ(0)+r)mod N=0, the sequence of its DRGs does not alter with different k index. Take FIG. 6A for instance (M=3, N=2, p=q=1, r=0), there is half-duplex constraint between DRG 611 and DRG 613 no matter which DRP is (e.g. in DRPs 610 and 620). In order to enhance the possibility of discovering or communicating all UEs (devices) in proximity, in an exemplary embodiment, setting an altering probability P_{altering} (0≦P_{altering}≦1) would provide the opportunity for altering the sequence of DRGs in the generated hopping DRPs with respect to the row of original DRP satisfying (gₗ(0)+r)mod N=0. There are N! possible permutations of altering sequence.

After altering the sequence of DRG 611 and DRG 615 in the first generated hopping DRP (k=1) (i.e. DRP 620) as shown in FIG. 6B, there is an opportunity that the UEs in DRG 611 are able to receive the signals transmitted from the UEs in DRG 613.

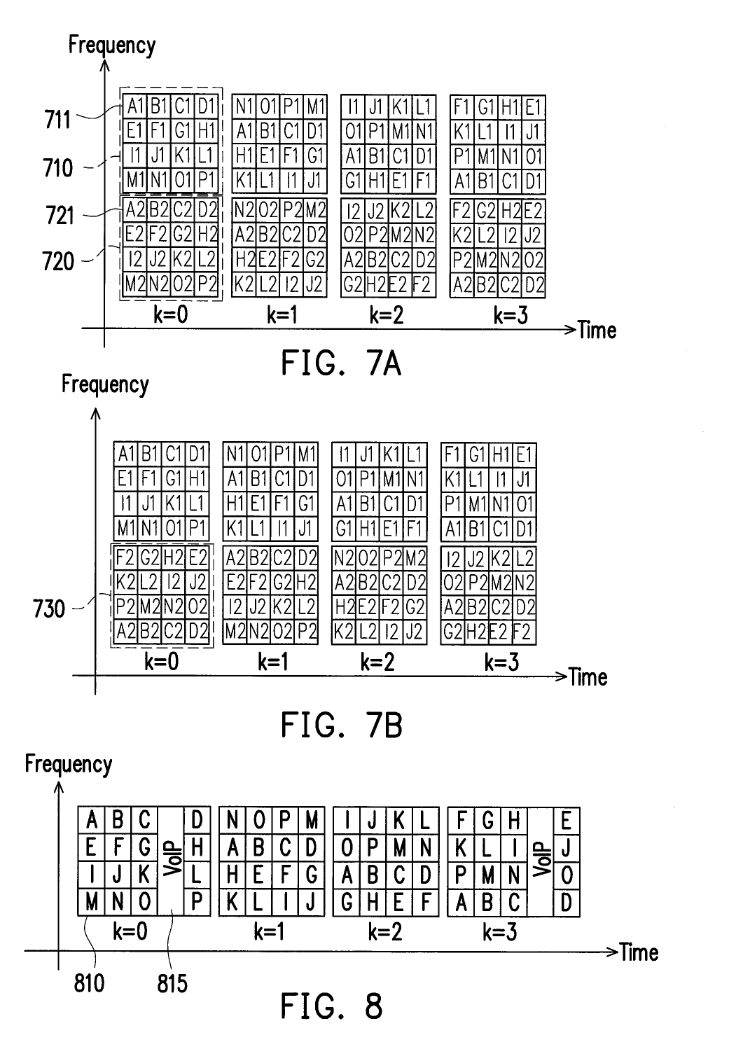

In one exemplary embodiment, the scheduling device further divides each of the resource groups in the time-frequency domain of each of the resource patterns with frequency division multiplexing (FDM). Suppose that the size of a DRG is J DRBs, where J≧2. The J DRBs in a DRG are not constrained by continuity. Every DRG in the original DRP can be divided into several parts. Each part follows the rule of two equations for resource allocation, and constructs sub-DRPs. FIG. 7A shows the case that every DRG is divided into two parts with FDM. For example, DRG 711 of sub-DRP 710 and DRG 721 of sub-DRP 720 are divided from a DRG. The second part of sub-DRPs (i.e. sub-DRP 730) can be interchanged randomly as shown in FIG. 7B, so that partial half-duplex constraint in the same DRG can be overcome. However, the DRGs at the first row of original DRP (without hopping, dividing and interchanging) are still subject to half-duplex constraint without any improvement. This problem can be resolved by introducing P_{altering} mentioned above.

In one exemplary embodiment, the scheduling device further assigns at least one of the resource groups in the time-frequency domain of one of the resource patterns with the same time index for voice over internet protocol (VoIP) or assigns the resource blocks for the non-D2D communications between the two of the resource patterns. For example, if D2D discovery or D2D communication is assumed to adopt UL resource (UL spectrum for FDD and UL subframes for TDD), there may exist VoIP requirements or any other cellular UL extra needs. VoIP requires the overall end-to-end delay (from UE to UE) to be below a certain time value. For this reason, a suitable solution is to semi-persistently intersperse small number of cellular UL subframes among contiguous D2D subframes. FIG. 8 illustrates that this concern does not affect the utilization of the rule of two equations (1) and (2) shown above, that is to say, the DRGs in a DRP are not constrained by continuity. DRGs of VoIP 815 are with iₗ(0)=3 in DRP 810.

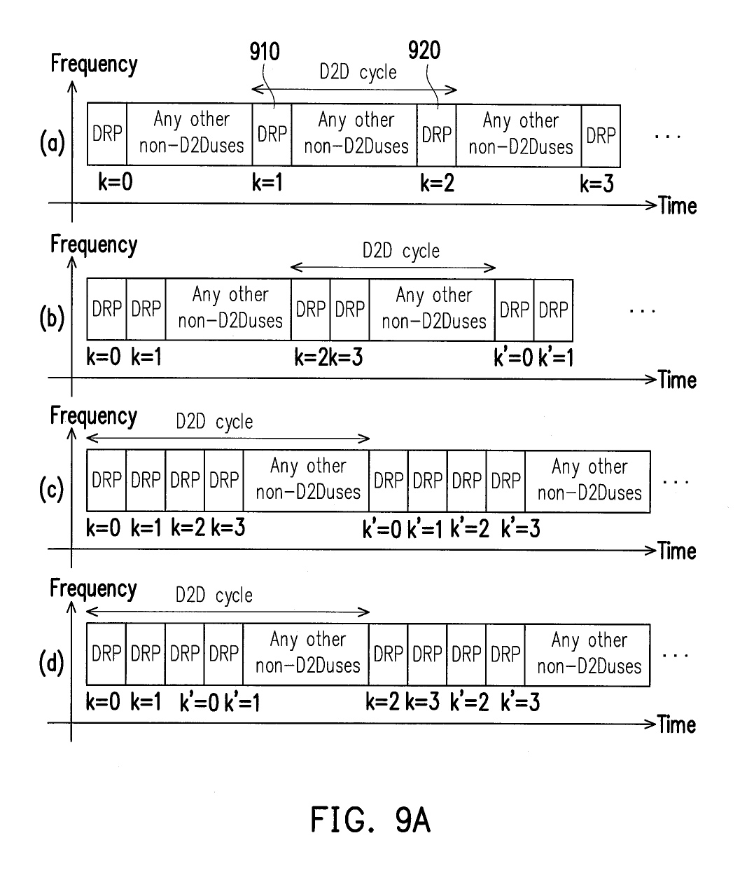

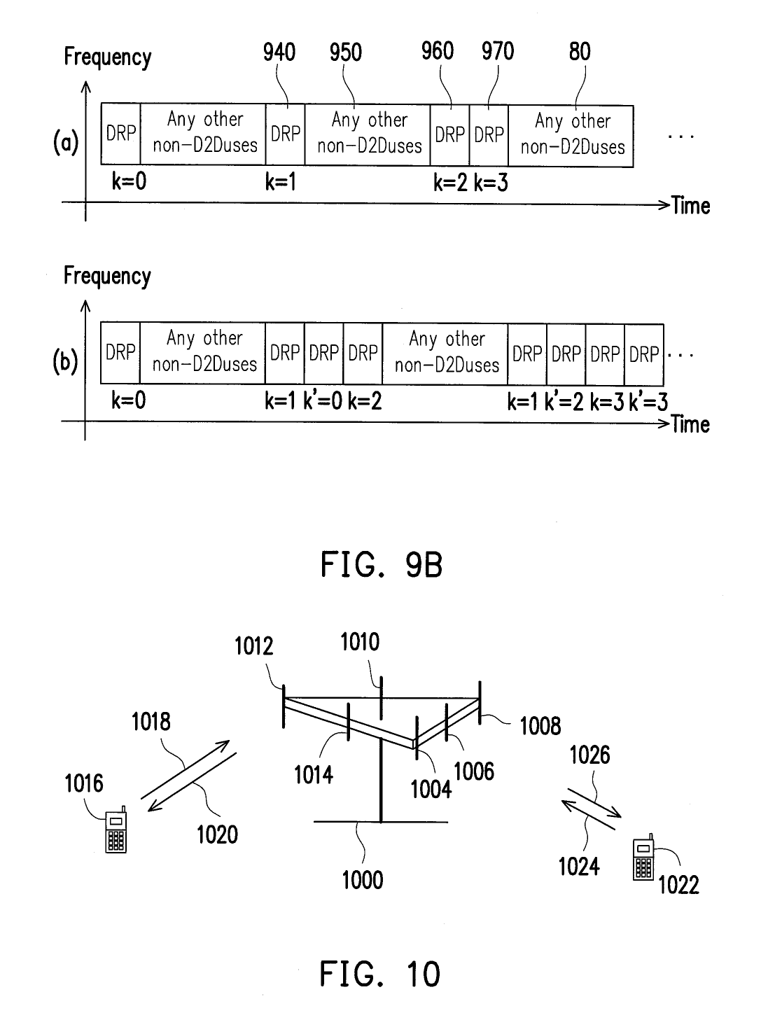

As far as DRPs allocated in overall time-frequency resource structure are concerned, there are two classifications: regular D2D cycle and irregular D2D cycle as shown in FIG. 9A and FIG. 9B, respectively. For example, in FIG. 9A (a), D2D cycle w a time period of DRP 910, a non-D2D period 920, and so forth. In FIG. 9B (a), a non-D2D period that uses 950 is after a DRP 940, and a non-D2D period that uses 980 is after two DRPs 960 and 970. Notice that the constituents in the DRP with k index are different from the constituents in the DRP with k′ index. No matter how do the DRPs be allocated, the proposed resource allocation method is still available.

Furthermore, in other view of the present disclosure, a first UE utilizes a first resource group to perform the D2D communication, and a second UE utilizes a second resource group to perform the D2D communication, wherein there exists at least one of a plurality of resource patterns such that a time index of the first resource group and a time index of the second group are different. Furthermore, a third UE utilizes a third resource group to perform the D2D communication and there exists at least one of the resource patterns such that the time index of the third resource group are different from the time index of second resource group or the frequency index of the third group and the frequency index of the second group are not adjacent in the frequency domain. For the first resource group, there are at least two resource patterns such that the frequency index of the first resource group in the two resource patterns are different.

The aforementioned examples are for practical implementation. There are still many possible implementations that would satisfy equations (3) to (9) of the proposed resource allocation method. The proposed resource allocation method can be applied to not only LTE-based D2D ProSe but also any other wireless communication systems for resource allocation or scheduling.

In view of the aforementioned descriptions, the present disclosure is suitable for being used in a wireless communication system and is able to allocate D2D resources for D2D discovery or D2D communication signal transmission to resolve the three issues (half-duplex constraint, near-far problem (RF blocking), and deep fade of fading channel). Furthermore, the advantages of DRG-based resource allocation are listed as follows: (1) Computation complexity is reduced for both base station and the UE acting as virtual base station. (2) Latency for both base station and the UE acting as virtual base station is lowered. (3) Power saving for both base station and the UE acting as virtual base station can be achieved. (4) An opportunity that the signal transmission of the UEs with similar properties can be allocated in the same DRG can be provided. Thus, the overall D2D operation can be performed more efficiently. (5) The separation between successive carriers (time intervals) of same information-bearing signal equals or exceeds the coherence bandwidth (coherence time) of the channel providing diversity gain for each DRB can be guaranteed. In addition, the diversity can be exploited to enhance the probability of successful signal transmission over wireless channel such that frequency diversity gain for frequency-selective channel, and Time diversity gain for time-varying channel can be achieved.

The proposed resource allocation method described above can be applied to or implemented in exemplary wireless communication systems and devices described below. In addition, the proposed resource allocation method is described mainly in the context of the 3GPP architecture reference model. However, it is understood that with the disclosed information, one skilled in the art could easily adapt for use and implement aspects of the disclosure in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, or some other modulation techniques.

The term “base station” in this disclosure may be the access network (AN) which may also be a fixed station or macro site used for communicating with the terminals and may also be referred to as an access point, a Node B, an enhanced base station, an eNodeB, or some other terminology. The term “user equipment (UE)” in this disclosure may be an access terminal (AT) which may also be called a wireless communication device, terminal, access terminal or some other terminology.

FIG. 10 shows a multiple access wireless communication system according to one embodiment of the disclosure. An access network 1000 (AN) includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal 1016 (AT) is in communication with antennas 1012 and 1014, where antennas 1012 and 1014 transmit information to access terminal 1016 over forward link 1020 and receive information from access terminal 1016 over reverse link 1018. Access terminal (AT) 1022 is in communication with antennas 1006 and 1008, where antennas 1006 and 1008 transmit information to access terminal (AT) 1022 over forward link 1026 and receive information from access terminal (AT) 1022 over reverse link 1024. In a FDD system, communication links 1018, 1020, 1024 and 1026 may use different frequency for communication. For example, forward link 1020 may use a different frequency than that used by reverse link 1018.

Each group of antennas and/or the area in which they are designed to communicate is often referred to as a sector of the access network. In the embodiment, antenna groups each are designed to communicate to access terminals in a sector of the areas covered by access network 1000.

In communication over forward links 1020 and 1026, the transmitting antennas of access network 1000 may utilize beamforming in order to improve the signal-to-noise ratio of forward links for the different access terminals 1016 and 1022. Also, an access network using beamforming to transmit to access terminals scattered randomly through its coverage normally causes less interference to access terminals in neighboring cells than an access network transmitting through a single antenna to all its access terminals.

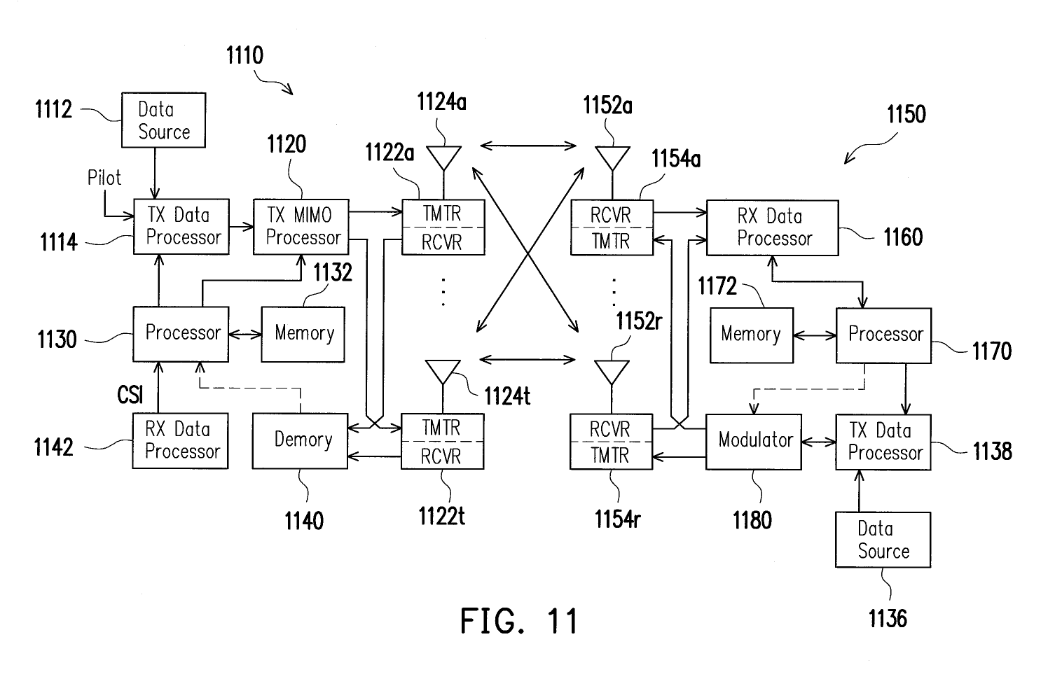

FIG. 11 is a simplified block diagram of an embodiment of a transmitter system 1110 (also known as the access network or base station) and a receiver system 1150 (also known as access terminal (AT) or user equipment (UE)) in a MIMO system 1100. At the transmitter system 1110, traffic data for a number of data streams is provided from a data source 1112 to a transmit (TX) data processor 1114.

In one embodiment, each data stream is transmitted over a respective transmit antenna. TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 1130.

The modulation symbols for all data streams are then provided to a TX MIMO processor 1120, which may further process the modulation symbols (e.g., for OFDM). TX MIMO processor 1120 then provides NT modulation symbol streams to NT transmitters (TMTR) 1122a through 1122t. In certain embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 1122a through 1122t are then transmitted from NT antennas 1124a through 1124t, respectively.

At receiver system 1150, the transmitted modulated signals are received by NR antennas 1152a through 1152r and the received signal from each antenna 1152 is provided to a respective receiver (RCVR) 1154a through 1154r. Each receiver 1154 conditions (e.g., filters, amplifies, and downconverts) a respective received signal, digitizes the conditioned signal to provide samples, and further processes the samples to provide a corresponding “received” symbol stream.

An RX data processor 1160 then receives and processes the NR received symbol streams from NR receivers 1154 based on a particular receiver processing technique to provide NT “detected” symbol streams. The RX data processor 1160 then demodulates, deinterleaves, and decodes each detected symbol stream to recover the traffic data for the data stream. The processing by RX data processor 1160 is complementary to that performed by TX MIMO processor 1120 and TX data processor 1114 at transmitter system 1110.

A processor 1170 periodically determines which pre-coding matrix to use (discussed below). Processor 1170 formulates a reverse link message comprising a matrix index portion and a rank value portion.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by transmitters 1154a through 1154r, and transmitted back to transmitter system 1110.

At transmitter system 1110, the modulated signals from receiver system 1150 are received by antennas 1124, conditioned by receivers 1122, demodulated by a demodulator 1140, and processed by a RX data processor 1142 to extract the reserve link message transmitted by the receiver system 1150. Processor 1130 then determines which pre-coding matrix to use for determining the beamforming weights then processes the extracted message.

Memory 1132 may be used to temporarily store some buffered/computational data from 1140 or 1142 through Processor 1130, store some buffed data from 1112, or store some specific program codes. And Memory 1172 may be used to temporarily store some buffered/computational data from 1160 through Processor 1170, store some buffed data from 1136, or store some specific program codes.

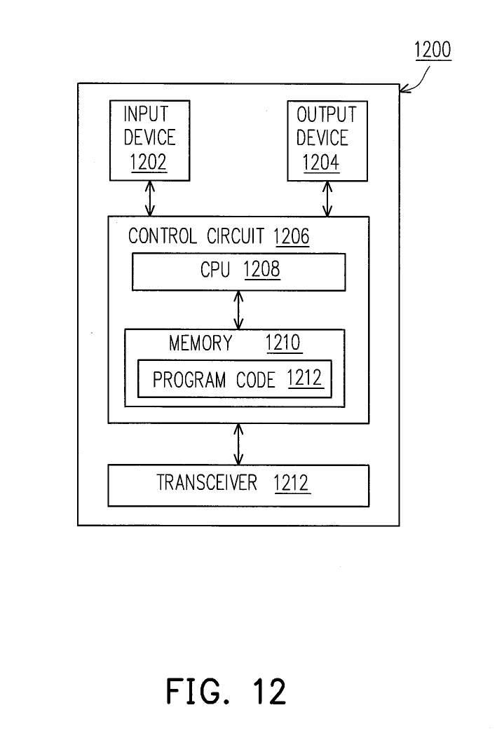

Turning to FIG. 12, this figure shows an alternative simplified functional block diagram of a communication device according to one embodiment of the disclosure. As shown in FIG. 12, the communication device 1200 in a wireless communication system can be utilized for realizing base stations (or ANs) or the UEs (or ATs) 1016 and 1022 in FIG. 10, and the wireless communications system is preferably the LTE system. The communication device 1200 may include an input device 1202, an output device 1204, a control circuit 1206, a central processing unit (CPU) 1208, a memory 1210, a program code 1212, and a transceiver 1214. The control circuit 1206 executes the program code 1212 in the memory 1210 through the CPU 1208, thereby controlling an operation of the communications device 1200. In this disclosure, the operation of the communications device 1200 could also be the resource allocation method described at step S201˜S205 in FIG. 2, and the resource allocation method could be executed by the control circuit 1206. The communications device 1200 can receive signals input by a user through the input device 1202, such as a keyboard or keypad, and can output images and sounds through the output device 1204, such as a monitor or speakers. The transceiver 1214 is used to receive and transmit wireless signals, delivering received signals to the control circuit 1206, and outputting signals generated by the control circuit 1206 wirelessly. In this disclosure, the outputting signals may comprises information related to the resource allocated results such as the allocated DRGs, frequency indices and time indices of the allocated DRGs, bandwidth and time period of DRP, etc. . . . The control circuit 1206 would transmit the information related to the resource allocated results using the transceiver 1214.

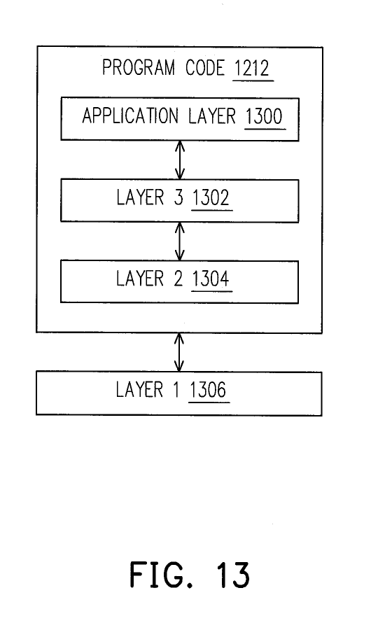

FIG. 13 is a simplified block diagram of the program code 1212 shown in FIG. 12 in accordance with one embodiment of the disclosure. In this embodiment, the program code 1212 includes an application layer 1300, a Layer 3 portion 1302, and a Layer 2 portion 1304, and is coupled to a Layer 1 portion 1306. The Layer 3 portion 1302 generally performs radio resource control, such as assigning DRBs, DPGs, and DRPs, determining frequency indices and time indices of the DPGs in each of the DRPs, and assigning DPGs to UEs, respectively, as described at aforementioned resource allocation method. The Layer 2 portion 1304 generally performs link control. The Layer 1 portion 1306 generally performs physical connections.

For LTE or LTE-A system, the Layer 2 portion 1304 may include a Radio Link Control (RLC) layer and a Medium Access Control (MAC) layer. The Layer 3 portion 1302 may include a Radio Resource Control (RRC) layer.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), a base station, an access terminal, a user equipment, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein (e.g. the proposed resource allocation method (i.e. S201˜S205 of FIG. 2)), and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed resource allocation method is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of the resource allocation method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the disclosure has been described in connection with various aspects, it will be understood that the disclosure is capable of further modifications. This application is intended to cover any variations, uses or adaptation of the disclosure following, in general, the principles of the disclosure, and including such departures from the present disclosure as come within the known and customary practice within the art to which the disclosure pertains.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A resource allocation method, used for a base station to assign resource blocks for device to device (D2D) communications of a plurality of user equipments (UEs), the method comprises:
assigning a plurality of resource patterns, wherein each of the plurality of resource patterns comprises resource groups, and each of the resource groups comprises the resource blocks;
determining frequency index and time index of each of the resource groups in a time-frequency domain for each of the plurality of resource patterns, and there exists at least one of the plurality of resource patterns such that the time index of a first resource group and the time index of a second group are different; and
assigning the resource groups of each of the plurality of resource patterns to the plurality of UEs respectively according to the frequency index and the time index of each of the resource groups in the time-frequency domain of each of the plurality of resource patterns.

2. The method according to claim 1, wherein there exists at least one of the plurality of resource patterns such that the time index of a third resource group are different from the time index of the second resource group or the frequency index of the third group and the frequency index of the second group are not adjacent in the frequency domain.

3. The method according to claim 1, wherein for the first resource group, there are at least two of the plurality of resource patterns such that the frequency index of the first resource group in the two of the plurality of resource patterns are different.

4. A resource allocation method for device to device (D2D) communications of a plurality of user equipments (UEs), the method comprises:
determining frequency index and time index of each of the resource groups in a time-frequency domain for each of a plurality of resource patterns, and the frequency index and the time index fulfil the following conditions:
$$0 \leq {g}_{l} ( k ) \leq M - 1 , ∀ l ∈ \{ 0 , 1 , … , L - 1 \} and$$
$$∀ k ∈ \{ 0 , 1 , … , K - 1 \}$$
$$0 \leq {i}_{l} ( k ) \leq N - 1 , ∀ l ∈ \{ 0 , 1 , … , L - 1 \} and$$
$$∀ k ∈ \{ 0 , 1 , … , K - 1 \}$$
$$( {g}_{{l}_{1}} ( k ) , {i}_{{l}_{1}} ( k ) ) \neq ( {g}_{{l}_{2}} ( k ) , {i}_{{l}_{2}} ( k ) ) , ∀ {l}_{1} , \\ {l}_{2} ∈ \{ 0 , 1 , … , L - 1 \} , {l}_{1} \neq {l}_{2} , ∀ k ∈ \{ 0 , 1 , … , K - 1 \}$$
$$∀ {l}_{1} , {l}_{2} , {l}_{3} ∈ \{ 0 , 1 , … , L - 1 \} , {l}_{1} \neq {l}_{2} \neq {l}_{3} \neq {l}_{1} , \\ ∃ k ∈ \{ 0 , 1 , … , K - 1 \} such that$$
$$\{ \begin{matrix}{i}_{{l}_{1}} ( k ) \neq {i}_{{l}_{2}} ( k ) & \\ \vert {g}_{{l}_{2}} ( k ) - {g}_{{l}_{3}} ( k ) \vert \geq 2 or & {i}_{{l}_{2}} ( k ) = {i}_{{l}_{3}} ( k )\end{matrix} \\ ∃ {k}_{1} , {k}_{2} ∈ \{ 0 , 1 , … , K - 1 \} , {k}_{1} \neq {k}_{2} , such that \\ {g}_{l} ( {k}_{1} ) \neq {g}_{l} ( {k}_{2} ) , ∀ l ∈ \{ 0 , 1 , … , L - 1 \} ;$$
wherein gₗ(k) and iₗ(k) are the frequency index and the time index of the l^{th} resource group in the k^{th} resource pattern, respectively; M is the number of frequency indices, N is the number of time indices for resource groups to reside in each of the plurality of resource patterns, and L is the number of UE groups in each of the plurality of resource patterns.

5. A resource allocation method for device to device (D2D) communications of a plurality of user equipments (UEs), the method comprises:
a first UE utilizes a first resource group to perform the D2D communication;
a second UE utilizes a second resource group to perform the D2D communication;
wherein there exists at least one of a plurality of resource patterns such that a time index of the first resource group and a time index of the second group are different.

6. The method according to claim 5, wherein a third UE utilizes a third resource group to perform the D2D communication and there exists at least one of the plurality of resource patterns such that the time index of the third resource group are different from the time index of second resource group or the frequency index of the third group and the frequency index of the second group are not adjacent in the frequency domain.

7. The method according to claim 5, wherein for the first resource group, there are at least two of the plurality of resource patterns such that the frequency index of the first resource group in the two of the plurality of resource patterns are different.

8. A resource allocation method for device to device (D2D) communications of a plurality of user equipments (UEs), the method comprises:
determining frequency index and time index of each of resource groups in a time-frequency domain for each of the plurality of resource patterns, and the frequency index and the time index fulfil the following conditions:
gₗ(k)=(gₗ(0)+p·k mod M)mod M
iₗ=(k)=(iₗ(0)+q·k·(gₗ(0)+r)mod N)mod N
, wherein k is index of the plurality of resource patterns, M is the number of occupying spectra of the resource groups in each of the plurality of resource patterns, N is the number of time periods of the resource groups in each of the plurality of resource patterns, p is a positive integer which is relatively prime with M, q is a positive integer which is relatively prime with N, r is an integer in the range {0, 1, . . . , N−1}, gₗ(k) is the frequency index of the l^{th} resource group in the k^{th} resource pattern, iₗ(k) is the time index of the l^{th} resource group in the k^{th} resource pattern.

9. The method according to claim 8, wherein a first base station and a second base station use different r value for the UEs to derive the time index and frequency index.

10. A base station, comprising
a transceiver which transmits and receives wireless signals;
a control circuit to the transceiver and is configured for:
assigning a plurality of resource patterns, wherein each of the plurality of resource patterns comprises resource groups, and each of the resource groups comprises resource blocks;
determining frequency index and time index of each of the resource groups in a time-frequency domain of each of the plurality of resource patterns, and there exists at least one of the plurality of resource patterns such that the time index of a first resource group and the time index of a second group are different; and
assigning the resource groups of each of the plurality of resource patterns to a plurality of UEs respectively according to the frequency index and the time index of each of the resource groups in the time-frequency domain of each of the plurality of resource patterns.

11. The base station according to claim 10, wherein the control circuit is further configured for:
there exists at least one of the plurality of resource patterns such that the time index of a third resource group are different from the time index of the second resource group or the frequency index of the third group and the frequency index of the second group are not adjacent in the frequency domain.

12. The base station according to claim 10, wherein the control circuit is further configured for:
for the first resource group, there are at least two of the plurality of resource patterns such that the frequency index of the first resource group in the two of the plurality of resource patterns are different.

13. A base station, comprising
a transceiver which transmits and receives wireless signals;
a control circuit to the transceiver and is configured for:
assigning a plurality of resource patterns, wherein each of the plurality of resource patterns comprises resource groups, and each of the resource groups comprises resource blocks;
determining frequency index and time index of each of the resource groups in a time-frequency domain of each of the plurality of resource patterns, and the frequency index and the time index fulfil the following conditions:
$$0 \leq {g}_{l} ( k ) \leq M - 1 , ∀ l ∈ \{ 0 , 1 , … , L - 1 \} and$$
$$∀ k ∈ \{ 0 , 1 , … , K - 1 \}$$
$$0 \leq {i}_{l} ( k ) \leq N - 1 , ∀ l ∈ \{ 0 , 1 , … , L - 1 \} and$$
$$∀ k ∈ \{ 0 , 1 , … , K - 1 \}$$
$$( {g}_{{l}_{1}} ( k ) , {i}_{{l}_{1}} ( k ) ) \neq ( {g}_{{l}_{2}} ( k ) , {i}_{{l}_{2}} ( k ) ) , ∀ {l}_{1} , \\ {l}_{2} ∈ \{ 0 , 1 , … , L - 1 \} , {l}_{1} \neq {l}_{2} , ∀ k ∈ \{ 0 , 1 , … , K - 1 \}$$
$$∀ {l}_{1} , {l}_{2} , {l}_{3} ∈ \{ 0 , 1 , … , L - 1 \} , {l}_{1} \neq {l}_{2} \neq {l}_{3} \neq {l}_{1} , \\ ∃ k ∈ \{ 0 , 1 , … , K - 1 \} such that$$
$$\{ \begin{matrix}{i}_{{l}_{1}} ( k ) \neq {i}_{{l}_{2}} ( k ) & \\ \vert {g}_{{l}_{2}} ( k ) - {g}_{{l}_{3}} ( k ) \vert \geq 2 or & {i}_{{l}_{2}} ( k ) = {i}_{{l}_{3}} ( k )\end{matrix} \\ ∃ {k}_{1} , {k}_{2} ∈ \{ 0 , 1 , … , K - 1 \} , {k}_{1} \neq {k}_{2} , such taht \\ {g}_{l} ( {k}_{1} ) \neq {g}_{l} ( {k}_{2} ) , ∀ l ∈ \{ 0 , 1 , … , L - 1 \} ;$$
wherein gₗ(k) and iₗ(k) are the frequency index and the time index of the l^{th} resource group in the k^{th} resource pattern, respectively; M is the number of frequency indices, N is the number of time indices for resource groups to reside in each of the plurality of resource patterns, and L is the number of UE groups in each of the plurality of resource patterns.

14. A base station, comprising
a transceiver which transmits and receives wireless signals;
a control circuit to the transceiver and is configured for:
assigning a plurality of resource patterns, wherein each of the plurality of resource patterns comprises resource groups, and each of the resource groups comprises resource blocks;
determining frequency index and time index of each of resource groups in a time-frequency domain for each of the plurality of resource patterns, and the frequency index and the time index fulfil the following conditions:
gₗ(k)=(gₗ(0)+p·k mod M)mod M
iₗ(k)=(iₗ(0)+q·k·(gₗ(0)₊r)mod N)mod N
, wherein k is index of the plurality of resource patterns, M is the number of occupying spectra of the resource groups in each of the plurality of resource patterns, N is the number of time periods of the resource groups in each of the plurality of resource patterns, p is a positive integer which is relatively prime with M, q is a positive integer which is relatively prime with N, r is an integer in the range {0, 1, . . . , N−1}, gₗ(k) is the frequency index of the l^{th} resource group in the k^{th} resource pattern, iₗ(k) is the time index of the l^{th} resource group in the k^{th} resource pattern.

15. A user equipment, comprising
a transceiver which transmits and receives wireless signals;
a control circuit to the transceiver and is configured for:
determining frequency index and time index of each of the resource groups in a time-frequency domain of each of the plurality of resource patterns, and the frequency index and the time index fulfil the following conditions
gₗ(k)=(gₗ(0)+p·k mod M)mod M
iₗ(k)=(iₗ(0)+q·k·(gₗ(0)+r)mod N)mod N
, wherein k is index of the plurality of resource patterns, M is the number of occupying spectra of the resource groups in each of the plurality of resource patterns, N is the number of time periods of the resource groups in each of the plurality of resource patterns, p is a positive integer which is relatively prime with M, q is a positive integer which is relatively prime with N, r is an integer in the range {0, 1, . . . , N−1}, gₗ(k) is the frequency index of the l^{th} resource group in the k^{th} resource pattern, iₗ(k) is the time index of the l^{th} resource group in the k^{th} resource pattern.
